(19) United States
(12) Patent Application Publication
(10) Pub. No.: US 2026/0044250 A1
(43) Pub. Date: Feb. 12, 2026

(54) INTERFACE INTERACTION

(71) Applicant: Beijing Zitiao Network Technology Co., Ltd., Haidian District (CN)

(72) Inventor: Tong Xing, Beijing (CN)

(21) Appl. No.: 19/291,865

(22) Filed: Aug. 6, 2025

(30) Foreign Application Priority Data
Aug. 7, 2024 (WO) PCT/CN2024/110493

(51) Int. Cl. G06F 3/0483; G06F 3/0484

(52) U.S. Cl. CPC G06F 3/0483; G06F 3/0484

(57) ABSTRACT

A method, a device and a storage medium for interface interaction. In the method, an access request associated with a target application installed on a display device is received via a controller associated with a display device, and a first profile page of a first user is displayed in the display device in response to the access request. The first profile page includes a first area, and the first area includes a plurality of tabs. In the method, based on the first instruction received via the controller, an indicator is moved among the plurality of tabs to determine a target tab, and at least one content item corresponding to the target tab is displayed in a second area of the first profile page.

### CROSS-REFERENCE

This application claims the benefit of PCT Application No. PCT/CN2024/110493 filed on Aug. 7, 2024, entitled “METHOD, APPARATUS, DEVICE AND STORAGE MEDIUM FOR INTERFACE INTERACTION”, which is hereby incorporated by reference in its entirety.

### FIELD

Example embodiments of the present disclosure generally relate to the field of computers, and more particularly, to interface interaction.

### BACKGROUND

In recent years, with the development of technologies, large-screen electronic devices such as televisions also support installation of a wide variety of applications. A state of a user browsing media content on a large-screen electronic device is usually passive and relaxed. It is a focus of people's attention how to enable the user to browse media content more easily on the large-screen electronic device.

### SUMMARY

In a first aspect of the present disclosure, a method for interface interaction is provided. In the method, an access request associated with a target application installed on a display device is received via a controller associated with a display device, and a first profile page of a first user is displayed in the display device in response to the access request. The first profile page includes a first area, and the first area includes a plurality of tabs. In the method, based on the first instruction received via the controller, an indicator is moved among the plurality of tabs to determine a target tab, and at least one content item corresponding to the target tab is displayed in a second area of the first profile page.

In a second aspect of the present disclosure, an electronic device is provided. The electronic device includes at least one processing unit and at least one memory. The at least one memory is coupled to the at least one processing unit and stores instructions for execution by the at least one processing unit. The instructions, when executed by the at least one processing unit, cause the electronic device to perform the method of the first aspect.

In a third aspect of the present disclosure, a computer-readable storage medium is provided. The computer-readable storage medium stores a computer program, and the computer program is executable by the processor to perform the method of the first aspect.

It should be appreciated that the content described in this section is not intended to limit critical features or essential features of embodiments of the disclosure, nor is it intended to limit the scope of the disclosure. Other features of the present disclosure will become readily appreciated from the following description.

### BRIEF DESCRIPTION OF DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, in which:

FIG. 1 illustrates a schematic diagram of an example environment in which some embodiments of the present disclosure may be implemented in real time;

FIGS. 2A-2F illustrate example interfaces according to some embodiments of the present disclosure;

FIG. 3 shows a flowchart of an example process of interface interaction according to some embodiments of the present disclosure;

FIG. 4 illustrates a schematic structural block diagram of an example apparatus for interface interaction according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the headings of any section/subsection provided herein are not limiting. Various embodiments are described throughout herein, and any type of embodiments can be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as non-exclusive inclusion, that is, “including but not limited to”. The term “based on” should be read as “based at least in part on”. The term “one embodiment” or “the embodiment” should be read as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

Embodiments of the present disclosure may relate to data, acquisition and/or use of data, etc. by a user. These aspects shall follow respective legal regulations and related regulations. In embodiments of the present disclosure, all data collection, acquisition, processing, forwarding, usage, and the like, are carried out with user knowledge and confirmation. Accordingly, when implementing the embodiments of the present disclosure, the user should be informed of the types of data or information that may be involved, a usage range, a usage scenario, and the like in an appropriate manner according to relevant legal regulations, and the authorization of the user shall be obtained. The specific informing and/or authorization manner may vary according to actual situations and application scenarios, and the scope of the present disclosure is not limited in this aspect.

In the present description and the embodiments, if profile information processing is involved, the processing is performed on the basis of legitimacy (for example, the consent of subject of the profile information is obtained, or necessary for fulfillment of a contract, etc.), and will be performed only within a prescribed range or a predetermined range. The user rejecting to process profile information other than necessary information required for processing the basic function will not affect the user in using the basic function.

As briefly mentioned above, large-screen electronic devices such as televisions also support installation of a wide variety of applications, and a state of a user browsing media content on a large-screen electronic device is usually passive and relaxed. It is a focus of people's attention how to enable the user to browse media content more easily on the large-screen electronic device.

Embodiments of the present disclosure provide solutions for interface interaction. According to one solution, an access request associated with a target application installed on a display device may be received via a controller associated with the display device. In response to the access request, a first profile page of a first user is displayed in the display device. The first profile page includes a first area, and the first area includes a plurality of tabs. Based on the first instruction received via the controller, an indicator is moved among the plurality of tabs to determine a target tab, and at least one content item corresponding to the target tab is displayed in a second area of the first profile page.

In this way, in embodiments of the present disclosure, a layout of a profile page in the display device (such as a television) that interacts via the controller may be optimized. In addition, in embodiments of the present disclosure, the content related to the profile page may be organized with a plurality of tabs, thereby improving efficiency of content display.

Various example implementations of the solution will be described in detail below with reference to the accompanying drawings.

### Example Environment

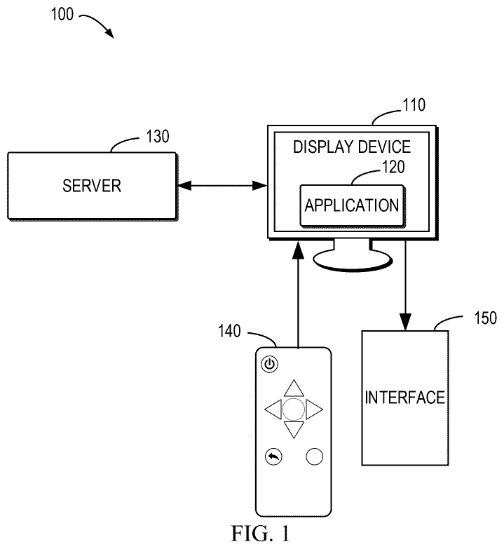

FIG. 1 illustrates a schematic diagram of an example environment 100 in which embodiments of the present disclosure may be implemented. As shown in FIG. 1, the example environment 100 may include a display device 110.

In the environment 100 of FIG. 1, the display device 110 may be run an application 120 configured to provide and view media content. The application 120 may be any suitable type of application, examples of which may include, but are not limited to: video applications, social applications, or other suitable applications. The user may interact with the application 120 via a controller 140 communicatively connected to the display device 110.

In the environment 100 of FIG. 1, when the application 120 is active, the display device 110 may display the interface 150 through the application 120. The interface 150 may include various pages provided by the application 120, such as a play page of the media content or a profile information interface of the user.

In some embodiments, the display device 110 communicates with the server 130 to provide services for the application 120. The display device 110 may be any type of suitable device that needs to be controlled by the controller, such as a television, a projector, etc. The display device 110 may include, for example, a display device, and the display device may include an image generation component and an optical display component configured to generate a corresponding image on a screen or a curtain of the display device.

The server 130 may be an independent physical server, a server cluster or a distributed system composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, etc. The server 130 may provide background services for the application 120 that supports virtual scenes in the display device 110.

A communication connection may be established between the server 130 and the display device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this respect. In embodiments of the present disclosure, the server 130 and the display device 110 may implement signaling interaction through the communication connection between the server 130 and the display device 110.

It should be understood that the structures and functions of the various elements in the environment 100 are described for exemplary purposes only, and do not imply any limitation on the scope of the present disclosure.

Some example embodiments of the present disclosure will be described below with continued reference to the accompanying drawings.

### Example Interaction

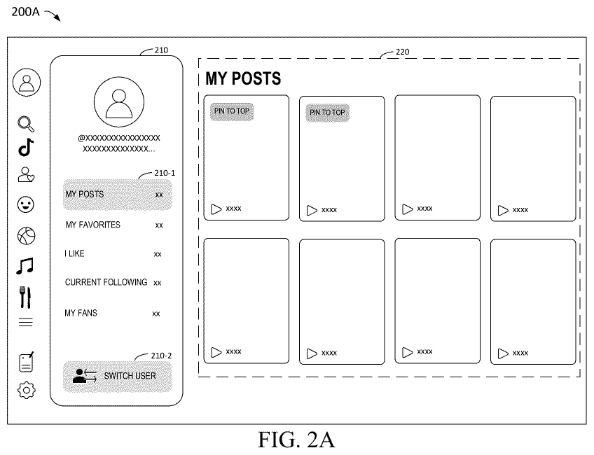

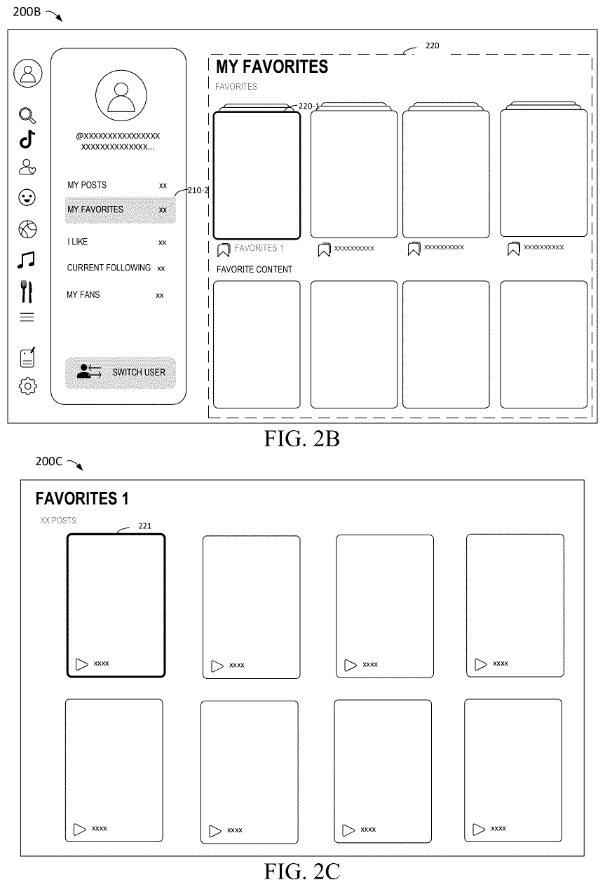

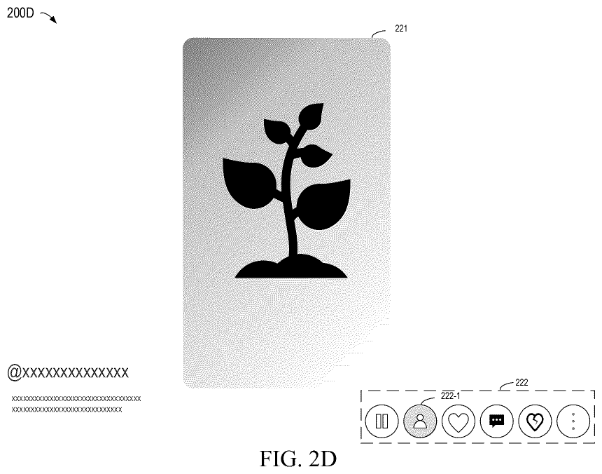

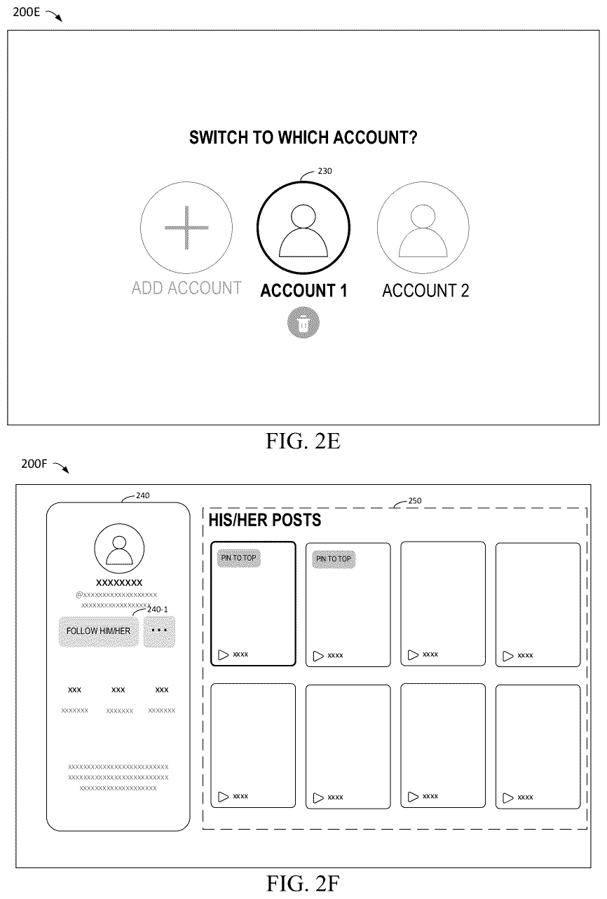

FIGS. 2A-2F illustrate example interfaces 200A-200F according to some embodiments of the present disclosure. The interface 200A to the interface 200F may be provided, for example, by the display device 110 shown in FIG. 1.

In some embodiments, an access request associated with a target application installed on the display device 110 may be received via the controller 140 associated with the display device 110. As an example, the controller may be a remote control or other input devices of the display device 110, and the target application may be any suitable type of application for interface interaction.

In some embodiments, the display device 110 may display a first profile page of the first user in response to the access request. The first profile page includes a first area, and the first area includes a plurality of tabs. The plurality of tabs may include a plurality of content tabs. The plurality of content tabs correspond to different media content sets associated with the first user. The first user corresponds to a current user of the target application.

As an example, as shown in FIG. 2A, the display device 110 may display an interface 200A. The interface 200A may be a profile page of the current user (i.e., the first profile page of the first user). The interface 200A includes a first area 210 and a second area 220. The first area 210 includes a plurality of tabs. The second area 220 presents different media content sets associated with the first user.

In some embodiments, the display device 110 may move an indicator among the plurality of tabs to determine a target tab based on a first instruction received via the controller.

As an example, as shown in FIG. 2A and FIG. 2B, the display device 110 may receive a downward movement instruction entered by the user through the controller, to move the indicator from the tab 210-1 to the tab 210-2.

In some embodiments, after the target tab is determined, the display device 110 may display at least one content item corresponding to the target tab in the second area of the first profile page.

As shown in FIG. 2B, after it is determined that the tab 210-2 is selected, the display device 110 may display, in the second area 220, a plurality of contents in “my favorites” corresponding to the tab 210-2. The content may be a media content such as a video or a picture, or the content may be a text content. The “my favorites” may include favorites columns and favorite content columns. The favorites may include the media content collected by multiple users.

In some embodiments, the display device 110 may move the indicator to the first content item in the second area in response to receiving the second instruction via the controller.

As an example, as shown in FIG. 2B, in this case, the indicator is hovering on the tab 210-2, and in response to the second instruction received via the controller, the display device 110 may move the indicator from the tab 210-2 to the first content item 220-1 in the second area 220. It should be noted that the second instruction may be a confirmation instruction, a rightward movement instruction, or other instructions that may achieve movement functions.

In some embodiments, the display device 110 may determine, in response to receiving a third instruction via the controller, whether the indicator corresponds to a second content item at a predetermined location in the second area. Specifically, as shown in FIG. 2B, after the third instruction is received, the display device 110 may determine whether the indicator is on the leftmost content item in the second area. When the indicator is on the leftmost content item in the second area 220, the display device 110 may move the indicator to the target tab in the first area in response to the indicator corresponding to the second content item at the predetermined location in the second area. By determining the current location of the indicator through the display device 110, the user may be prevented from making erroneous operations when selecting different media contents.

As an example, as shown in FIG. 2B, in this case, the indicator stays on the first content item 220-1 of the second area 220. In response to receiving the third instruction sent by the controller 140, the display device 110 may determine whether the content item 220-1 is at the leftmost side (i.e., predetermined location) of the second area 220. After the display device 110 determines that the content item 220-1 is at the leftmost side of the second area 220, the display device 110 may move the indicator to the tab 210-2 in the first area 210.

In some embodiments, the first content item corresponds to a media content set, and the display device 110 may receive a selection of the first content item via the controller, and display a plurality of media contents in the media content set corresponding to the first content item.

As an example, as shown in FIG. 2B, the content item 220-1 may be a favorite of the media content, and the favorite includes a plurality of media contents. The display device 110 may receive a selection instruction of the content item 220-1 input by the controller, and display the interface 200C shown in FIG. 2C. The interface 200C includes a plurality of media contents in the content item 220-1.

In some embodiments, the display device 110 may receive, via the controller, a selection of a first media content from the plurality of media contents, and play the first media content.

Specifically, after the user selects the first media content through the controller 140, an interface 200D for playing the selected media content as shown in FIG. 2D may be displayed in the display device 110. The interface 200D includes the selected media content 221, the username of the creator of the media content, the profile of the media content, and the control bar 222. The control bar 222 includes a plurality of controls for interacting with the media content 221. The user may input an indicator movement instruction through the controller 140 to select the target control.

Furthermore, the display device 110 may switch the display device to play a second media content of the plurality of media contents in response to receiving a fourth instruction via the controller.

As an example, as shown in FIG. 2D, when the indicator selects the media content 221, the display device 110 may switch the media content 221 to other media contents (i.e., the second media content) based on the fourth instruction input by the user through the controller 140.

In some embodiments, the first area 210 further includes a switching entry for switching the current account. As shown in FIG. 2A, the first area 210 includes an account switching entry 230. The display device 110 may display an interface 200E as shown in FIG. 2E in response to a selection instruction of the controller 140 for the account switch entry 230. The interface 200E includes information of a plurality of accounts. The account indicates an account corresponding to the current user. The display device 110 may receive a selection instruction of the controller 140 for any control in the interface 200E, and execute an event corresponding to the selected control. For example, the display device 110 may switch the current user to the target account in response to the selection instruction of the controller 140 for the target account.

In some embodiments, the display device 110 may receive, via the controller, a second access request associated with the target application. The display device 110 may display a second profile page of a second user in the display device in response to the second access request. The second profile page includes a third area and a fourth area, the third area displays an interactive control associated with the second user and/or description information of the second user, and the fourth area displays a set of media contents associated with the second user.

As an example, after the display device 110 receives the second access request associated with the target application, the display device 110 may display the interface 200F as shown in FIG. 2F. The interface 200F may be a profile homepage of the second user. The interface 200F includes a third area 240 and a fourth area 250. The third area 240 includes profile information of the second user and a plurality of interactive controls associated with the second user. The interactive control may include a control 240-1 for following the second user. The fourth area 250 includes a plurality of media contents published by the second user.

In some examples, the display device 110 may modify the text prompt and function in the control 240-1 based on the relationship between the first user and the second user. For example, when the first user does not follow the second user, the display device 110 may set the text prompt in the control 240-1 as “follow him/her”, and the function of the control 240-1 is to follow the second user. When the first user has followed the second user, the display device 110 may set the text prompt in the control 240-1 as “unfollow”, and the function of the control 240-1 is to unfollow the second user. When the first user and the second user follow each other, the display device 110 may set the text prompt in the control 240-1 as “friend” to indicate that the first user and the second user follow each other. Based on this, it may always remind the current user of the relationship with the second user, thereby improving the browsing experience of the current user on the profile homepage of other users.

In some embodiments, the display device 110 may display a play page of a target media content associated with the second user. The play page includes a target access entry corresponding to the second user. The display device 110 may receive, via the controller, a selection of the target access entry. The selection indicates the second access request. The user may access the homepage of a publisher of the media content via the play page of the media content, making the interaction process more convenient.

As an example, as shown in FIG. 2E, the interface 200E further includes an access entry 222-1 of the profile homepage of the publisher of the media content 221. The display device 110 may receive the selection of the access entry 222-1 by the controller 140, and present the profile homepage of the publisher (i.e., the second user).

Based on the processes described above, embodiments of the present disclosure optimize the layout of the profile page in the display device (such as a television) that interacts through the controller. In addition, embodiments of the present disclosure may also organize the content related to the profile page with a plurality of tabs, thereby improving the efficiency of content display.

### Example Processes

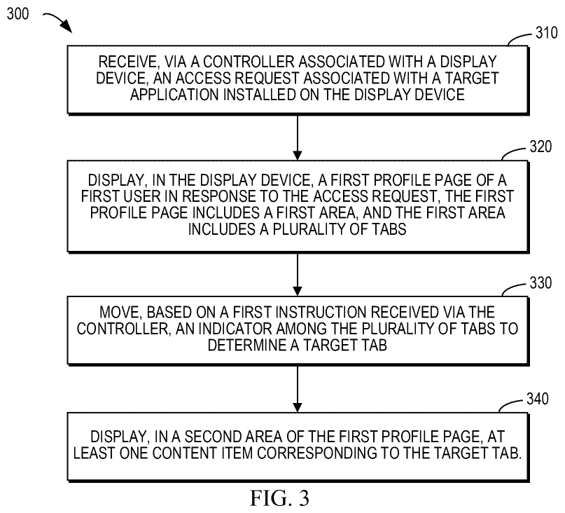

FIG. 3 illustrates a flowchart of an example process 300 of interface interaction according to some embodiments of the present disclosure. The process 300 may be implemented at the display device 110. The process 300 will be described below with reference to FIG. 1.

As shown in FIG. 3, at block 310, the display device 110 may receive, via a controller associated with the display device, an access request associated with a target application installed on the display device.

At block 320, the display device 110 may display, in the display device, a first profile page of a first user in response to the access request. The first profile page includes a first area, and the first area includes a plurality of tabs.

At block 330, the display device 110 may move an indicator among the plurality of tabs to determine a target tab based on a first instruction received via the controller.

At block 340, the display device 110 may display, in a second area of the first profile page, at least one content item corresponding to the target tab.

In some embodiments, the plurality of tabs include a plurality of content tabs. The plurality of content tabs correspond to different media content sets associated with the first user.

In some embodiments, the method 300 further includes moving the indicator to a first content item in the second area in response to receiving a second instruction via the controller.

In some embodiments, the method 300 further includes: in response to receiving a third instruction via the controller, determining whether the indicator corresponds to a second content item at a predetermined location in the second area; and in response to the indicator corresponding to the second content item at the predetermined location in the second area, moving the indicator to the target tab in the first area.

In some embodiments, the first content item corresponds to a media content set, and the display device 110 may receive, via the controller, a selection of the first content item; and display, in the display device, a plurality of media contents in the media content set corresponding to the first content item.

In some embodiments, the first content item corresponds to a media content set, and the method 300 further includes: receiving, via the controller, a selection of a first media content of the plurality of media contents; playing the first media content in the display device; and in response to receiving a fourth instruction via the controller, switching the display device to play a second media content of the plurality of media contents.

In some embodiments, the first user corresponds to a current account of the target application.

In some embodiments, the first area further includes a switching entry for switching the current account.

In some embodiments, the access request is a first access request, and the method 300 further includes: receiving, via the controller, a second access request associated with the target application; and in response to the second access request, displaying a second profile page of a second user in the display device. The second profile page includes a third area and a fourth area, the third area displays an interactive control associated with the second user and/or description information of the second user, and the fourth area displays a set of media contents associated with the second user.

In some embodiments, to receive the second access request associated with the target application via the controller, the display device 110 may display a play page of a target media content associated with the second user; and receive, via the controller, a selection of the target access entry. The play page includes a target access entry corresponding to the second user, and the selection indicates the second access request.

### Example Apparatus and Device

Embodiments of the present disclosure further provide a corresponding apparatus for implementing the above method or process. FIG. 4 shows a schematic block diagram of an example apparatus 400 for interface interaction according to some embodiments of the present disclosure. The apparatus 400 may be implemented as an electronic device or included in an electronic device. The various modules/components in the apparatus 400 may be implemented by hardware, software, firmware, or any combination thereof.

As shown in FIG. 4, the apparatus 400 includes an access request receiving module 410, a first profile page displaying module 420, a target tab determining module 430 and a content displaying module 440. The access request receiving module is configured to receive, via a controller associated with a display device, an access request associated with a target application installed on the display device. The first profile page displaying module 420 is configured to display, in the display device, a first profile page of a first user in response to the access request. The first profile page includes a first area, and the first area includes a plurality of tabs. The target tab determining module 430 is configured to move, based on a first instruction received via the controller, an indicator among the plurality of tabs to determine a target tab. The content displaying module 440 configured to display, in a second area of the first profile page, at least one content item corresponding to the target tab.

In some embodiments, the plurality of tabs include a plurality of content tabs. The plurality of content tabs correspond to different media content sets associated with the first user.

In some embodiments, the apparatus 400 further includes an indicator movement module. The indicator movement module is configured to move the indicator to a first content item in the second area in response to receiving a second instruction via the controller.

In some embodiments, the indicator movement module is further configured to in response to receiving a third instruction via the controller, determine whether the indicator corresponds to a second content item at a predetermined location in the second area; and in response to the indicator corresponding to the second content item at the predetermined location in the second area, move the indicator to the target tab in the first area.

In some embodiments, the indicator movement module is further configured to receive, via the controller, a selection of the first content item; and display, in the display device, a plurality of media contents in the media content set corresponding to the first content item.

In some embodiments, the indicator movement module is further configured to receive, via the controller, a selection of a first media content of the plurality of media contents; play the first media content in the display device; and in response to receiving a fourth instruction via the controller, switch the display device to play a second media content of the plurality of media contents.

In some embodiments, the first user corresponds to a current account of the target application.

In some embodiments, the first area further includes a switching entry for switching the current account.

In some embodiments, the access request is a first access request, and the apparatus 400 further includes a second profile page displaying module. The second profile page displaying module is configured to receive, via the controller, a second access request associated with the target application; and in response to the second access request, display a second profile page of a second user in the display device. The second profile page includes a third area and a fourth area, the third area displays an interactive control associated with the second user and/or description information of the second user, and the fourth area displays a set of media contents associated with the second user.

In some embodiments, the second profile page displaying module is further configured to display a play page of a target media content associated with the second user; and receive, via the controller, a selection of the target access entry. The play page includes a target access entry corresponding to the second user, and the selection indicates the second access request.

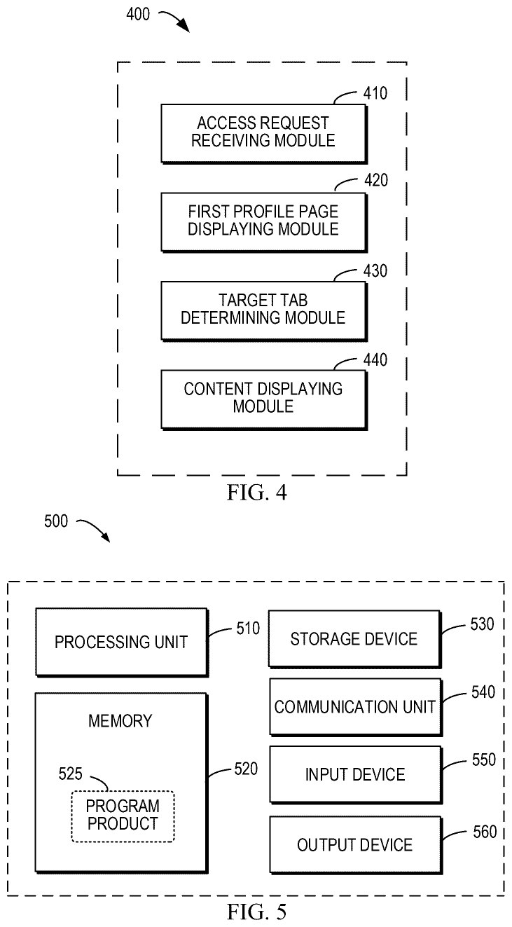

FIG. 5 illustrates a block diagram of an electronic device 500 in which one or more embodiments of the present disclosure can be implemented. It should be appreciated that the electronic device 500 illustrated in FIG. 5 is merely exemplary and should not constitute any limitation on the functionality and scope of the embodiments described herein. The electronic device 500 illustrated in FIG. 5 may be used in the electronic device.

As illustrated in FIG. 5, the electronic device 500 is in the form of a general-purpose electronic device. Components of the electronic device 500 may include, but are not limited to, one or more processors or processing units 510, a memory 520, a storage device 530, one or more communications units 540, one or more input devices 550, and one or more output devices 560. The processing unit 510 may be an actual or virtual processor and can perform various processes according to programs stored in the memory 520. In a multiprocessor system, a plurality of processing units execute computer executable instructions in parallel, so as to improve the parallel processing capability of the electronic device 500.

The electronic device 500 typically includes a plurality of computer storage media. Such media may be any available media that are accessible by electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium such as a flash drive, a magnetic disk, or any other medium that can be used to store information and/or data and that can be accessed within the electronic device 500.

The electronic device 500 may further include additional removable/non-removable, volatile/nonvolatile storage media. Although not illustrated in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not illustrated) by one or more data media interfaces. The memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Thus, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speaker, printer, etc. The electronic device 500 may also communicate with one or more external devices (not illustrated) such as a storage device, a display device, or the like through the communication unit 540 as required, and communicate with one or more devices that enable a user to interact with the electronic device 500, or communicate with any device (e.g., a network card, a modem, or the like) that enables the electronic device 500 to communicate with one or more other electronic devices. Such communication may be performed via an input/output (I/O) interface (not illustrated).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for interface interaction, comprising:
receiving, via a controller associated with a display device, an access request associated with a target application installed on the display device;
displaying, in the display device, a first profile page of a first user in response to the access request, the first profile page comprising a first area, and the first area comprising a plurality of tabs;
moving, based on a first instruction received via the controller, an indicator among the plurality of tabs to determine a target tab; and
displaying, in a second area of the first profile page, at least one content item corresponding to the target tab.

2. The method of claim 1, wherein the plurality of tabs comprise a plurality of content tabs, and the plurality of content tabs correspond to different media content sets associated with the first user.

3. The method of claim 1, further comprising:
in response to receiving a second instruction via the controller, moving the indicator to a first content item in the second area.

4. The method of claim 3, further comprising:
in response to receiving a third instruction via the controller, determining whether the indicator corresponds to a second content item at a predetermined location in the second area; and
in response to the indicator corresponding to the second content item at the predetermined location in the second area, moving the indicator to the target tab in the first area.

5. The method of claim 3, wherein the first content item corresponds to a media content set, the method further comprising:
receiving, via the controller, a selection of the first content item; and
displaying, in the display device, a plurality of media contents in the media content set corresponding to the first content item.

6. The method of claim 5, further comprising:
receiving, via the controller, a selection of a first media content of the plurality of media contents;
playing the first media content in the display device;
in response to receiving a fourth instruction via the controller, switching the display device to play a second media content of the plurality of media contents.

7. The method of claim 1, wherein the first user corresponds to a current account of the target application.

8. The method of claim 7, wherein the first area further comprises a switching entry for switching the current account.

9. The method of claim 1, wherein the access request is a first access request, and the method further comprises:
receiving, via the controller, a second access request associated with the target application; and
in response to the second access request, displaying a second profile page of a second user in the display device, the second profile page comprising a third area and a fourth area, the third area displaying an interactive control associated with the second user and/or description information of the second user, and the fourth area displaying a set of media contents associated with the second user.

10. The method of claim 9, wherein receiving, via the controller, the second access request associated with the target application comprises:
displaying a play page of a target media content associated with the second user, the play page comprising a target access entry corresponding to the second user; and
receiving, via the controller, a selection of the target access entry, the selection indicating the second access request.

11. An electronic device, comprising:
at least one processing unit; and
at least one memory, coupled to the at least one processing unit and storing instructions for execution by the at least one processing unit, the instructions, when executed by the at least one processing unit, causing the electronic device to perform operations comprising:
receiving, via a controller associated with a display device, an access request associated with a target application installed on the display device;
displaying, in the display device, a first profile page of a first user in response to the access request, the first profile page comprising a first area, and the first area comprising a plurality of tabs;
moving, based on a first instruction received via the controller, an indicator among the plurality of tabs to determine a target tab; and
displaying, in a second area of the first profile page, at least one content item corresponding to the target tab.

12. The electronic device of claim 1, wherein the plurality of tabs comprise a plurality of content tabs, and the plurality of content tabs correspond to different media content sets associated with the first user.

13. The electronic device of claim 1, wherein the operations further comprise:
in response to receiving a second instruction via the controller, moving the indicator to a first content item in the second area.

14. The electronic device of claim 3, wherein the operations further comprise:
in response to receiving a third instruction via the controller, determining whether the indicator corresponds to a second content item at a predetermined location in the second area; and
in response to the indicator corresponding to the second content item at the predetermined location in the second area, moving the indicator to the target tab in the first area.

15. The electronic device of claim 3, wherein the first content item corresponds to a media content set, and the operations further comprise:
receiving, via the controller, a selection of the first content item; and
displaying, in the display device, a plurality of media contents in the media content set corresponding to the first content item.

16. The electronic device of claim 5, wherein the operations further comprise:
receiving, via the controller, a selection of a first media content of the plurality of media contents;
playing the first media content in the display device;
in response to receiving a fourth instruction via the controller, switching the display device to play a second media content of the plurality of media contents.

17. The electronic device of claim 7, wherein the first area further comprises a switching entry for switching the current account.

18. The electronic device of claim 1, wherein the access request is a first access request, and the operations further comprise:
receiving, via the controller, a second access request associated with the target application; and
in response to the second access request, displaying a second profile page of a second user in the display device, the second profile page comprising a third area and a fourth area, the third area displaying an interactive control associated with the second user and/or description information of the second user, and the fourth area displaying a set of media contents associated with the second user.

19. The electronic device of claim 9, wherein receiving, via the controller, the second access request associated with the target application comprises:
displaying a play page of a target media content associated with the second user, the play page comprising a target access entry corresponding to the second user; and
receiving, via the controller, a selection of the target access entry, the selection indicating the second access request.

20. A non-transitory computer-readable storage medium having a computer program stored thereon, the computer program being executable by a processor to perform operations comprising:
receiving, via a controller associated with a display device, an access request associated with a target application installed on the display device;
displaying, in the display device, a first profile page of a first user in response to the access request, the first profile page comprising a first area, and the first area comprising a plurality of tabs;
moving, based on a first instruction received via the controller, an indicator among the plurality of tabs to determine a target tab; and
displaying, in a second area of the first profile page, at least one content item corresponding to the target tab.
